(19) United States
(12) Patent Application Publication
(10) Pub. No.: US 2010/0070673 A1
(43) Pub. Date: Mar. 18, 2010

(54) HIGH PCI EXPRESS SIGNAL TRANSMISSION APPARATUS AND CONTROL METHOD THEREOF

(75) Inventors: Byung Kwon Jung, Daejeon (KR); Yong Seok Choi, Daejeon (KR); Seong Woon Kim, Chungcheongnam-do (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/415,324

(22) Filed: Mar. 31, 2009

(30) Foreign Application Priority Data
Aug. 13, 2008 (KR) 10-2008-0079570

(51) Int. Cl. G06F 13/20

(52) U.S. Cl. 710/313

(57) ABSTRACT

Provided are a high PCI express signal transmission apparatus and a control method thereof. A high PCIe signal transmission apparatus for transceiving data of a computer storage device with an external device, the high PCIe signal transmission apparatus includes a host adapter receiving the data of the storage device through the PCIe signal, and converting the received PCIe signal into an optical signal to transmit the converted optical signal, and a signal conversion processor receiving the optical signal from the host adapter, converting the received optical signal into an electrical signal, and transmitting the converted electrical signal to an corresponding external device connection unit.

### CROSS-REFERENCE TO RELATED APPLICATIONS

This application claims priority under 35 U.S.C. §119 to Korean Patent Application No. 10-2008-79570, filed on Aug. 13, 2008, the disclosure of which is incorporated herein by reference in its entirety.

### TECHNICAL FIELD

The present disclosure relates to a high PCI express signal transmission apparatus and a control method thereof, and in particular, to a high PCI express signal transmission apparatus and a control method thereof, which can transmit data through a fiber channel via the use of a Peripheral Component Interconnect (PCI) express signal.

### BACKGROUND

Generally, a Peripheral Component Interconnect express (PCIe) is for solving a bottleneck occurring in a case where various PCI devices share one parallel bus, and uses a serial bus providing a unidirectional transmission function of an effective transfer rate 2 Gbps (250 Mbytes/s) using two lines, as opposed to 32/64-bit PCI using a parallel bus scheme. Therefore, upon bi-directional transmission/receipt, the PCIe is configured with one lane combined with two serial buses to provide 2 Gbps transfer rate to each direction. The connection between two PCIe devices is commonly provided with one, two, four, eight, twelve, sixteen or thirty-two lanes. For example, sixteen-lane (x16) PCIe card can provide 250*16=4 Gbytes/s transfer rate to each direction.

In recent, a fiber channel is widely used as a high-speed interface technology. The fiber channel is a technology standardized in 1998, and provides data transmission through an optical fiber and the connection between devices using a serial interface. An example of a technology applying the fiber channel may include a storage area network (SAN).

An example of the storage area network is disclosed in a reference 1.

A technology disclosed in the reference 1 relates to a dual role optical disc drive (Korean Patent Publication No. 10-2008-008725), which enables to use an Optical Disc Drive (ODD) mounted in a desktop personal computer as an external optical disc drive in an external device such as a notebook personal computer. That is, the technology disclosed in the reference 1 mounts a bridge board for changing an AT Attachment Packet Interface (ATAPI) into a Universal Serial Board Interface (USB I/F), a USB connector and a change role switch in an optical disc drive mounted in a desktop personal computer, and thus enables a user to use the optical disc drive as an external optical disc drive by connecting an external device such as a notebook personal computer to the USB connector.

Another example of the storage area network is disclosed in the following reference 2.

A technology disclosed in the reference 2 relates to an optical USB external device connection system (Korean Patent Application No. 10-2008-017415 (2008.02.26 Application)), which includes a USB drive apparatus of a host computer for exchanging data with an external device including a USB terminal. Such a USB drive apparatus includes an optical USB terminal connected to a USB terminal of an external device to exchange data by an optical signal, a USB interface for inputting/outputting data through the optical USB terminal, and an optical-to-electrical converter disposed between the optical USB terminal and the USB interface to interconvert an optical signal and an electrical signal. The optical-to-electrical converter is connected to each other through an optical waveguide to transceive data through an optical signal, thereby enhancing a data transfer rate of a USB system.

However, there is limitation in that technologies of the references 1 and 2 does not enhance data transfer rate because of transmitting data in only a dual channel scheme or an optical signal USB scheme without carrying data in a high PCIe signal through an optical channel.

### SUMMARY

Accordingly, the present disclosure provides a high PCI express signal transmission apparatus and a control method thereof, which carry data of a storage device in a PCIe signal through an optical channel, thereby enhancing a data transfer rate.

According to an aspect, there is provided a high PCIe signal transmission apparatus for transceiving data of a computer storage device with an external device, the high PCIe signal transmission apparatus including: a host adapter receiving the data of the storage device through the PCIe signal, and converting the received PCIe signal into an optical signal to transmit the converted optical signal; and a signal conversion processor receiving the optical signal from the host adapter, converting the received optical signal into an electrical signal, and transmitting the converted electrical signal to an corresponding external device connection unit.

According to another aspect, there is provided a high PCIe signal transmission control method for transceiving data of a computer storage device with an external device, the high PCIe signal transmission control method including: converting the data of the storage device into the PCIe signal to transmit the converted PCIe signal; receiving the PCIe signal to convert the PCIe signal into an optical signal, and transmitting the optical signal through a fiber channel; and converting the optical signal received through the fiber channel into an electrical signal, and transmitting the converted electrical signal to an corresponding external device.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a high PCI express signal transmission apparatus according to an exemplary embodiment; and

FIG. 2 is a flowchart illustrating a high PCI express signal transmission process according to an exemplary embodiment.

### DETAILED DESCRIPTION OF EMBODIMENTS

A USB providing maximum 480 Mbps (60 Mbyte) transfer rate is widely used as a connection standard transmitting data stored in the computer, but the USB is insufficient for providing high-quality video streaming, etc (e.g., a streaming equipment provides functions such as recording and replay, in addition to single streaming) because of transmitting only 40-45 Mbyte due to the limitation of a host chipset speed of a computer. Therefore, an alternate connection standard is required that has a sufficient transmission bandwidth and easier migration, and satisfies compatibility to operate without changing the existing application and drive.

Accordingly, since PCIe satisfies such conditions, an exemplary embodiment proposes a method that transmits a PCIe signal through an optical channel for carrying data of a storage device in the PCIe signal and supporting disk mirroring, backup, perpetual storage, data search for perpetual storage, data portability between storage devices, data sharing between different services in a network, etc.

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Moreover, in description of an exemplary embodiment, the same element will be indicated as like reference numeral, and repeated description will be omitted.

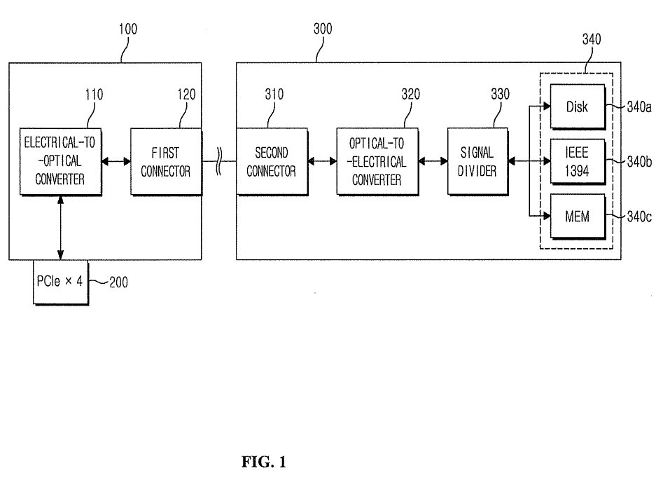

FIG. 1 is a block diagram of a high PCI express signal transmission apparatus according to an exemplary embodiment.

Referring to FIG. 1, a high PCIe signal transmission apparatus according to an exemplary embodiment includes a PCI express card 200 (hereinafter, referred to as a PCIe card 200), a host adapter 100, and a signal conversion processor 300. Herein, the PCIe card 200 is connected to the host adapter 100 by the connection of two to eight lanes. The host adapter 100 includes an electrical-to-optical converter 110 for converting a PCIe signal received from the PCIe card 200 into an optical signal to output the converted signal, and a first connector 120 for transmitting a signal to an external device. The signal conversion processor 300 includes a second connector 310 connected to the first connector 120 of the host adapter 100 and separated from the first connector 120 by a distance set by a user, an optical-to-electrical converter 320 for converting an optical signal received through the second connector 310 into an electrical signal to output the converted signal, and a signal divider 330 for receiving the output signal of the optical-to-electrical converter 320, interpreting contents of the received signal to determine an external device for transmission, and transmitting data through one or more external device connection units 340. The signal divider 330 includes a controller for an external device connected to the external device connection unit 340, and can easily be implemented with Field-Programmable Gate Array (FPGA).

The host adapter 100 and the signal conversion processor 300 provide the transmission and receipt of data through a fiber channel.

Since the second connector 310 of the signal conversion processor 300 may be provided with a USB type as well as a long-distance connection type, it may be directly connected to the host adapter 100.

The external device connection unit 340 includes a disk connector 340a, an IEEE 1394 interface 340c and a storage connector 340c to be connected to all sorts of external devices.

Since the host adapter 100 is disposed in a computer storing data to transmit and the signal conversion processor 300 is disposed between an external device to receive data and the host adapter 100, the number of the external device connection unit 340 of the signal conversion processor 300 may be added according to the number and kind of external devices intended to connect.

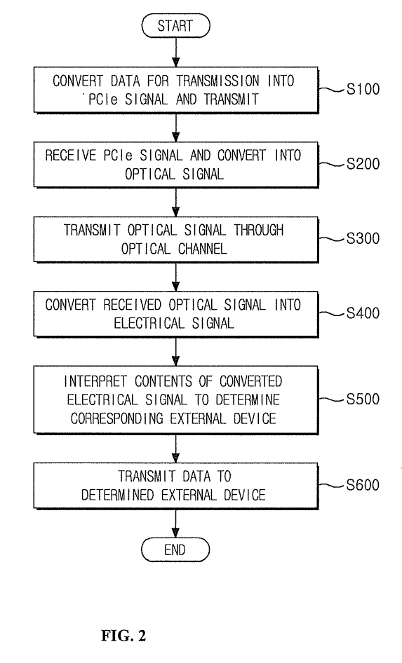

The operation process of an exemplary embodiment including such a configuration will be described below with reference to FIG. 2.

Referring to FIG. 2, data of a computer storage device (not shown) intended to transmit is converted into a PCIe signal through the PCIe card 200 to be transmitted to the host adapter 100 in step S100. At this point, the PCIe card 200 is connected to the host adapter 100 by foul-lane connection, and the number of the lanes is adjusted according to a bandwidth intended to support. For example, if the bandwidth intended to support is 1 Gbytes/s, the four-lane connection is required. However, when 2 Gbytes/s bandwidth is required, the PCIe card 200 is connected to the host adapter 100 by four-lane connection.

When the host adapter 100 receives the PCIe signal converted in the step S100, the received PCIe signal is converted into an optical signal by the electrical-to-optical converter 110 in step S200, and thereafter the converted optical signal is transmitted through the fiber channel in step S300.

At this point, since the fiber channel supports three kinds of topologies such as point-to-point, an arbitrated loop and a cross point, it supports the connection between the connected host adapter 100 and the signal conversion processor 300.

Moreover, since the host adapter 100 transmits data by a block unit instead of a file unit to the signal conversion processor 300 of a near distance or a long distance through the fiber channel, it enable to transmit data at high transfer rate to an external device.

Subsequently, the optical-to-electrical converter 320 of the signal conversion processor 300 again converts an optical signal received through the fiber channel into an electrical signal in step S400, and transmits the converted signal to a corresponding external device. At this point, the signal divider 330, which includes a controller for an external device connected to the external device connection unit 340 after the optical signal is converted into the electrical signal, interprets contents of the electrical signal to determine an external device for receiving the electrical signal in step S500. Subsequently, the signal divider 330 transmits data to one or more external devices (e.g., an external disk drive, a Video Disk Drive (VDD), a home theater, a USB memory, a digital camera, a scanner, a printer, a Digital Video Recorder (DVR), a Digital Video Disk (DVD), etc) through the external device connection unit 340. This is for enabling the simultaneous connection and use of multiple devices.

The high PCIe signal transmission apparatus and the control method thereof according to an exemplary embodiment carry data of a computer storage device in the PCIe signal through the optical channel, thereby enhancing a data transfer rate for a near distance and a long distance.

The high PCIe signal transmission apparatus and the control method thereof according to an exemplary embodiment only add a simple transmission device, thereby enhancing data transfer efficiency more than a dual channel scheme or an optical signal USB scheme.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A high Peripheral Component Interconnect express (PCIe) signal transmission apparatus for transceiving data of a computer storage device with an external device, the high PCIe signal transmission apparatus comprising:
a host adapter receiving the data of the storage device through the PCIe signal, and converting the received PCIe signal into an optical signal to transmit the converted optical signal; and
a signal conversion processor receiving the optical signal from the host adapter, converting the received optical signal into an electrical signal, and transmitting the converted electrical signal to an corresponding external device connection unit.

2. The high PCIe signal transmission apparatus of claim 1, wherein the host adapter and the signal conversion processor transceive data through a fiber channel.

3. The high PCIe signal transmission apparatus of claim 1, wherein the host adapter comprises:
an electrical-to-optical converter converting the received PCIe signal into the optical signal to output the converted optical signal; and
a first connector transmitting a signal to the signal conversion processor.

4. The high PCIe signal transmission apparatus of claim 1, wherein the signal conversion processor comprises:
a second connector separated from the host adapter by a distance set by a user;
an optical-to-electrical converter converting the optical signal received through the second connector into an electrical signal to output the converted signal; and
a signal divider receiving the output signal of the optical-to-electrical converter, interpreting contents of the received signal to determine an external device for transmission, and transmitting data through one or more external device connection unit.

5. The high PCIe signal transmission apparatus of claim 4, wherein the second connector provided with a Universal Serial Bus (USB) type to be connected to the host adapter.

6. The high PCIe signal transmission apparatus of claim 4, wherein the signal divider comprises a controller for an external device connected to the signal conversion processor.

7. The high PCIe signal transmission apparatus of claim 1, wherein the external device connection unit comprises a disk connector transmitting the output signal of the host adapter to an external disk driver.

8. The high PCIe signal transmission apparatus of claim 7, wherein the external device connection unit comprises a storage connector transmitting the output signal of the host adapter to an external storage device.

9. The high PCIe signal transmission apparatus of claim 7, wherein the external device connection unit comprises an IEEE 1394 interface transmitting the output signal of the host adapter to an external device.

10. The high PCIe signal transmission apparatus of claim 1, wherein the external device comprises at least one of an external disk drive, a Video Disk Drive (VDD), a home theater, a USB memory, a digital camera, a scanner, a printer, a Digital Video Recorder (DVR) and a Digital Video Disk (DVD).

11. The high PCIe signal transmission apparatus of claim 1, wherein the PCIe signal is generated by a PCI express card.

12. The high PCIe signal transmission apparatus of claim 11, wherein the PCI express card is connected to the host adapter by the connection of two to sixteen lanes.

13. The high PCIe signal transmission apparatus of claim 1, wherein the host adapter is disposed in a computer storing data to transmit, and the signal conversion processor is disposed between an external device to receive data and the host adapter.

14. A high Peripheral Component Interconnect express (PCIe) signal transmission control method for transceiving data of a computer storage device with an external device, the high PCIe signal transmission control method comprising:
converting the data of the storage device into the PCIe signal to transmit the converted PCIe signal;
receiving the PCIe signal to convert the PCIe signal into an optical signal, and transmitting the optical signal through a fiber channel; and
converting the optical signal received through the fiber channel into an electrical signal, and transmitting the converted electrical signal to an corresponding external device.

15. The high PCIe signal transmission control method of claim 14, wherein the converting of the optical signal comprises converting the optical signal into the electrical signal, interpreting contents of the electrical signal to determine an external device for transmission, and transmitting data to one or more external devices.

16. The high PCIe signal transmission control method of claim 14, wherein the PCIe signal is generated by a PCI express card.
